(19) United States
(12) Patent Application Publication
(10) Pub. No.: US 2014/0046487 A1
(43) Pub. Date: Feb. 13, 2014

(54) Apparatus and Method for Controlling Motor Speed

(71) Applicant: Samsung Electro-Mechanics Co., Ltd., Suwon-si (KR)

(72) Inventor: Bon Young Gu, Suwon-Si (KR)

(21) Appl. No.: 13/804,094

(22) Filed: Mar. 14, 2013

(30) Foreign Application Priority Data
Aug. 7, 2012 (KR) 10-2012-0086231

(51) Int. Cl. G05B 15/02

(52) U.S. Cl. CPC G05B 15/02
USPC 700/275

(57) ABSTRACT

Disclosed herein are an apparatus and a method for controlling a motor speed, in which an actual speed is set to be a targeted speed by considering an order of a speed increase to be meaningless no more if it is determined that a previous error and a current error are unchanged according to a result of comparing errors between the targeted speed and the actual speed upon issuing an order of the speed increase of a motor.

### CROSS REFERENCE(S) TO RELATED APPLICATIONS

This application claims the benefit under 35 U.S.C. Section 119 of Korean Patent Application Serial No. 10-2012-0086231 entitled “Apparatus And Method For Controlling Motor Speed” filed on Aug. 7, 2012, which is hereby incorporated by reference in its entirety into this application.

### BACKGROUND OF THE INVENTION

1. Technical Field

The present invention relates to an apparatus and a method for controlling a motor speed, and more particularly, to an apparatus and a method for controlling a motor speed, in which an actual speed is set to be a targeted speed by considering an order of a speed increase to be meaningless no more if it is determined that a previous error and a current error are unchanged according to a result of comparing errors between the targeted speed and the actual speed upon issuing an order of the speed increase of a motor.

2. Description of the Related Art

A motor means a device that is used in various fields from home appliances such as a refrigerator, an air conditioner, and the like, to an information processing device such as a disk driver. In the case of a motor capable of controlling a speed such as a brushless direct current (BLDC) motor, a speed can be controlled by controlling a duty of a pulse width modulation (PWM) signal. That is, in order to control a speed of a motor, an actual speed of the motor is detected and the duty of the PWM is controlled according to a difference from a targeted speed (a speed set as a target).

In this case, the speed of the motor is detected using a hall signal and the targeted speed, that is, a control speed of the motor is obtained using the input PWM signal. The actual speed of the motor becomes the targeted speed by controlling the duty corresponding to an input to a PWM generator according to the difference between the actual speed and the targeted speed.

Therefore, the duty of the PWM is corrected by comparing the targeted speed with the actual speed and when the actual speed is smaller than the targeted speed, the duty of the PWM needs to be increased so as to increase the speed of the motor and when the actual speed is larger than the targeted speed, the duty of the PWM needs to be reduced so as to lower the speed of the motor.

However, even in the state in which the duty of the PWM is increased, when the speed of the motor is not increased, the duty of the PWM is continued to be increased and thus, the duty value becomes 100%. That is, since the actual speed does not reach the targeted speed even in the case of the duty value of 100%, efficiency may be degraded even though a large amount of power is consumed.

### RELATED ART DOCUMENT

### Patent Document

(Patent Document 1) JP Patent Laid-Open Publication No. Hei 8-223957

### SUMMARY OF THE INVENTION

An object of the present invention is to prevent a command of a speed increase from being issued and prevent power from being consumed by setting an actual speed to a targeted speed, since a command of a speed increase is considered to be meaningless no more and power is considered to be unnecessarily consumed if it is determined that errors are unchanged according to a result of comparing errors between a targeted speed and an actual speed after and before issuing an order so as to increase a speed of a motor.

Another object of the present invention is to prevent a speed from being increased and prevent power consumption by setting an actual speed to a targeted speed if it is determined that errors are unchanged according to a result of comparing errors between the targeted speed and the actual speed after and before issuing an order of a new targeted speed, after issuing an order by setting a new targeted speed that is a speed lower than the targeted speed.

According to an exemplary embodiment of the present invention, there is provided an apparatus for controlling a motor speed, including: a motor; a targeted speed external setting unit that sets a targeted speed for the motor; a speed comparing unit that compares the targeted speed with an actual speed of the motor; an error detecting unit that detects a difference between the targeted speed and the actual speed; a speed storage unit that is connected with the speed comparing unit to store the targeted speed and the actual speed; and an error storage unit that is connected with the error detecting unit to store the difference between the targeted speed and the actual speed.

The apparatus for controlling a motor speed may further include: a speed measuring unit that is connected with the motor to measure the actual speed and input the measured actual speed to the speed comparing unit; and a speed control unit that controls the speed of the motor based on the targeted speed set by the targeted speed external setting unit.

The error storage unit may store a difference E1 between the first targeted speed and a first actual speed that is the same speed at the time of setting a primary targeted speed first set by the targeted speed external setting unit, and store a difference E2 between a second targeted speed and a second actual speed at the time of setting the secondary targeted speed set so as to be increased more than the primary targeted speed by the targeted speed external setting unit.

The targeted speed external setting unit may set the second targeted speed to a final targeted speed when the E1 is equal to the E2, and set the first targeted speed to the final targeted speed when the E1 is different from the E2.

The speed control unit may perform a control to output the second targeted speed when the E1 is equal to the E2, and perform a control to output the first targeted speed when the E1 is different from the E2.

The apparatus for controlling a motor speed may further include: a targeted speed internal setting unit that is connected with the speed comparing unit and the speed control unit and sets a third targeted speed that is a new targeted speed different from the targeted speed set by the targeted speed external setting unit as long as the E1 is different from the E2, wherein the speed control unit controls the speed of the motor according to one selected from the targeted speed external setting unit or the targeted speed internal setting unit.

The third targeted speed may be higher than the first targeted speed and may be lower than the second targeted speed.

The error storage unit may store a difference E3 between the third targeted speed and a third actual speed at the time of setting a third order targeted speed by the targeted speed internal setting unit.

The targeted speed internal setting unit may set the third targeted speed to the final targeted speed when the E2 is equal to the E3, and set the second targeted speed to the final targeted speed when the E2 is different from the E3.

The speed control unit may perform a control to output the third targeted speed when the E2 is equal to the E3, and perform a control to output the second targeted speed when the E2 is different from the E3.

According to another exemplary embodiment of the present invention, there is provided a method for controlling a motor speed including: setting a primary targeted speed; detecting a difference E1 between a first targeted speed and a first actual speed that is the same speed as the first targeted speed; setting a secondary targeted speed; detecting a difference E2 between a second targeted speed and a second actual speed; and determining whether the E1 is equal to the E2.

The method for controlling a motor speed may further include: after the determining, setting the second targeted speed to a final targeted speed when the E1 is equal to the E2, and outputting, by the motor, the second targeted speed.

The method for controlling a motor speed may further include: after the determining, setting the first targeted speed to a final targeted speed when the E1 is different from the E2, and outputting, by the motor, the first targeted speed.

The method for controlling a motor speed may further include: after the determining, setting a third order targeted speed when the E1 is different from the E2, and detecting a difference E3 between the third targeted speed and a third actual speed, wherein the third targeted speed is higher than the first targeted speed and is lower than the second targeted speed.

The method for controlling a motor speed may further include: after the setting of the third targeted speed, setting the third targeted speed to a final targeted speed when the E2 is equal to the E3, and outputting, by the motor, the third targeted speed.

The method for controlling a motor speed may further include: after the setting of the third targeted speed, setting the second targeted speed to the final targeted speed when the E2 is different from the E3, and outputting, by the motor, the second targeted speed.

### BRIEF DESCRIPTION OF THE DRAWINGS

FIG. 1 is a block diagram of an apparatus for controlling a motor speed according to an embodiment of the present invention.

FIG. 2 is a block diagram of an apparatus for controlling a motor speed according to another embodiment of the present invention.

FIG. 3 is a flow chart of a method for controlling a motor speed according to an embodiment of the present invention.

### DESCRIPTION OF THE PREFERRED EMBODIMENTS

Hereinafter, exemplary embodiments of the present invention will be described in detail with reference to the accompanying drawings. However, this is only by way of example and therefore, the present invention is not limited thereto.

When technical configurations known in the related art are considered to make the contents obscure in the present invention, the detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

Hereinafter, the exemplary embodiments of the present invention will be described with reference to the accompanying drawings.

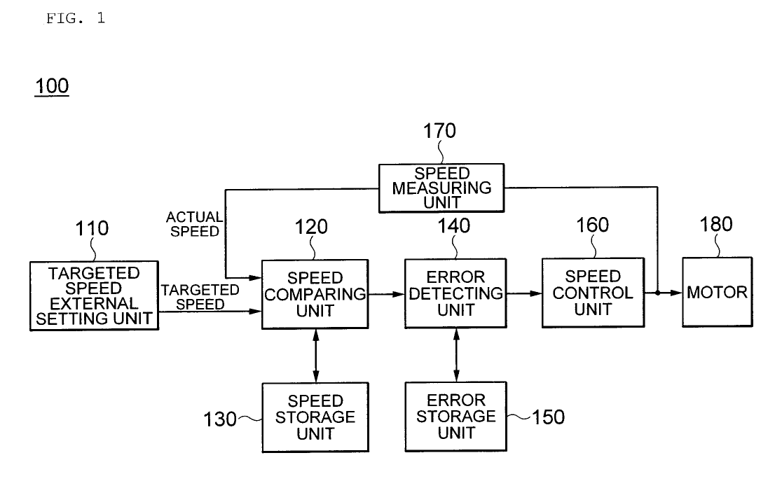

FIG. 1 is a block diagram of an apparatus 100 for controlling a motor speed according to an embodiment of the present invention.

Referring to FIG. 1, an apparatus 100 for controlling a motor speed according to an embodiment of the present invention may include a motor 180, a targeted speed external setting unit 110 that sets a targeted speed for the motor 180, a speed comparing unit 120 that compares a targeted speed with an actual speed of the motor 180, an error detecting unit 140 that detects a difference between the targeted speed and the actual speed, a speed storage unit 130 that is connected with the speed comparing unit 120 to store the targeted speed and the actual speed, and an error storage unit 150 that is connected with the error detecting unit 140 to store a difference between the targeted speed and the actual speed.

The targeted speed external setting unit 110 may set the targeted speed so as to allow the motor 180 to output a predetermined targeted speed, the speed comparing unit 120 compares the targeted speed with the actual speed using the targeted speed and the actual speed output by the motor 180, and the error detecting unit 140 may detect the difference between the targeted speed and the actual speed.

In this case, the apparatus for controlling a motor speed may further include a speed measuring unit 170 that is connected with the motor 180 to measure the actual speed and input the measured speed to the speed comparing unit 120, and a speed control unit 160 that controls the speed of the motor 180 based on the targeted speed set by the targeted speed external setting unit 110.

In addition, the error storage unit 150 may store a difference E1 between a first targeted speed at the time of setting a primary targeted speed first set by the targeted speed external setting unit 110 and a first actual speed that is the same speed as the same first targeted speed and a difference E2 between a second targeted speed at the time of setting a secondary targeted speed set to more increase than the primary targeted speed by the targeted speed external setting unit 110 and a second actual speed. Since the primary targeted speed first set by the targeted speed external setting unit 110 is a first speed set in the motor 180, the first targeted speed may be considered to be the same as the first actual speed. The second targeted speed at the time of setting the secondary targeted speed is a speed increased more than the first targeted speed and the second targeted speed may be equal to or different from the second actual speed according to the second targeted speed. Therefore, the difference E2 between the second targeted speed and the second actual speed may be calculated and when the second targeted speed is equal to the second actual speed, the E2 is zero and when the second targeted speed is different from the second actual speed, the E2 may correspond to the difference value between the second targeted speed and the second actual speed.

In this case, the targeted speed external setting unit 110 may set the second targeted speed to a final targeted speed when the E1 is equal to the E2 and may set the first targeted speed to the final targeted speed when the E1 is different from the E2. That is, since the first targeted speed is equal to the first actual speed, the E1 is zero. Here, the meaning that the E1 or the E2 is zero may indicate that the actual speed is equal to the targeted speed and may indicate that the actual speed is output as the targeted speed, which may indicate that the motor is normally operated.

Therefore, when the E1 is equal to the E2, the E1 is zero and therefore, the E2 is also zero, which may mean that the second targeted speed is equal to the second actual speed. That is, this means that the motor 180 is driven at the same speed as the second targeted speed set by the targeted speed external setting unit 110 and therefore, the targeted speed external setting unit 110 may set the second targeted speed to the final targeted speed.

However, the meaning that the E1 is different from the E2 may indicate that the E2 is not zero, which may mean that the second targeted speed is not equal to the second actual speed. In this case, despite the increase in the speed of the motor 180, this may mean that the motor 180 is driven at the speed that does not reach the increased targeted speed. The reason is that the actual speed cannot exceed the targeted speed. Therefore, in this case, the increase in the targeted speed does not have a meaning any more and causes the power consumption, such that the motor may be driven at the first targeted speed set before the second targeted speed. That is, even though the targeted speed is set to be the second targeted speed, when the actual speed is not the second targeted speed but is the first targeted speed smaller than the second targeted speed, there is no need to set the excessively targeted speed consuming only power for the output of the motor 180 and therefore, the first motor 180 is driven at the first targeted speed before the targeted speed is increased so that the targeted speed is equal to the actual speed.

As the same meaning, the speed control unit 160 may perform a control to output the second targeted speed when the E1 is equal to the E2 and may perform a control to output the first targeted speed when the E1 is different from the E2.

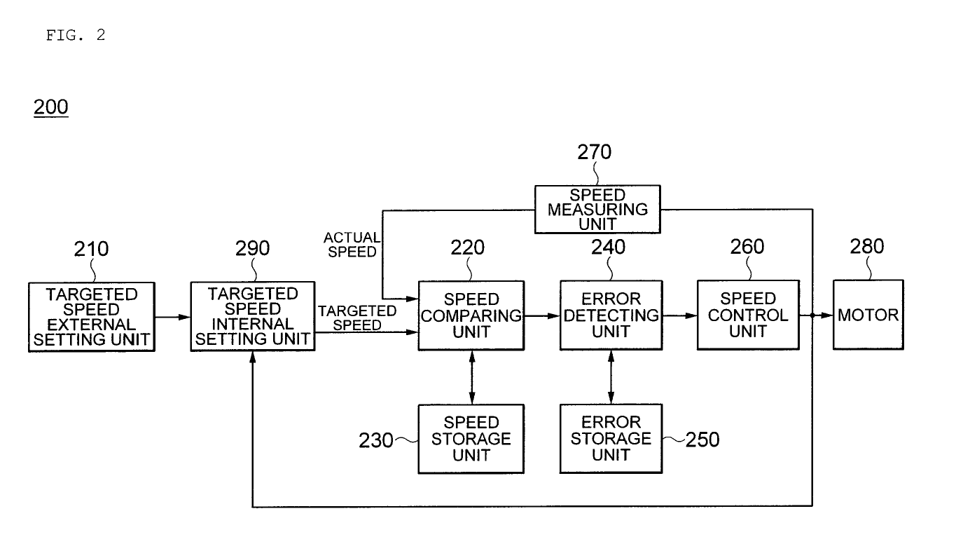

FIG. 2 is a block diagram of an apparatus 200 for controlling a motor speed according to another embodiment of the present invention. The overlapping portion with the portions described in FIG. 1 will not be repeatedly described.

Referring to FIG. 2, the apparatus 200 for controlling a motor speed according to another exemplary embodiment of the present invention may further include a targeted speed internal setting unit 290 that is connected with the speed comparing unit and the speed control unit 260 and sets a third targeted speed that is a new targeted speed different from the targeted speed set by the targeted speed external setting unit 210 as long as the E1 is different from the E2, wherein the speed control unit 260 may control a speed of the motor 280 according to one selected from the targeted speed external setting unit 210 or the targeted speed internal setting unit 290.

The targeted speed internal setting unit 290 is operated as long as the E1 is different from the E2, which means the case in which the second actual speed does not reach the second targeted speed. Therefore, it is possible to provide more opportunities of increasing the actual speed output by the motor 280 by newly setting the third targeted speed increased more than the first targeted speed and reduced more than the second targeted speed. Therefore, the third targeted speed may be higher than the first targeted speed and lower than the second targeted speed.

In this case, the error storage unit 250 may store a difference E3 between the third targeted speed at the time of setting a third order targeted speed by the targeted speed internal setting unit 290 and the third actual speed.

As the same logic described in FIG. 1, the targeted speed internal setting unit 290 may set the third targeted speed to the final targeted speed when the E2 is equal to the E3 and may set the second targeted speed to the final targeted speed when the E2 is different from the E3.

In this case, the speed control unit 260 may perform a control to output the third targeted speed when the E2 is equal to the E3 and may perform a control to output the second targeted speed when the E2 is different from the E3.

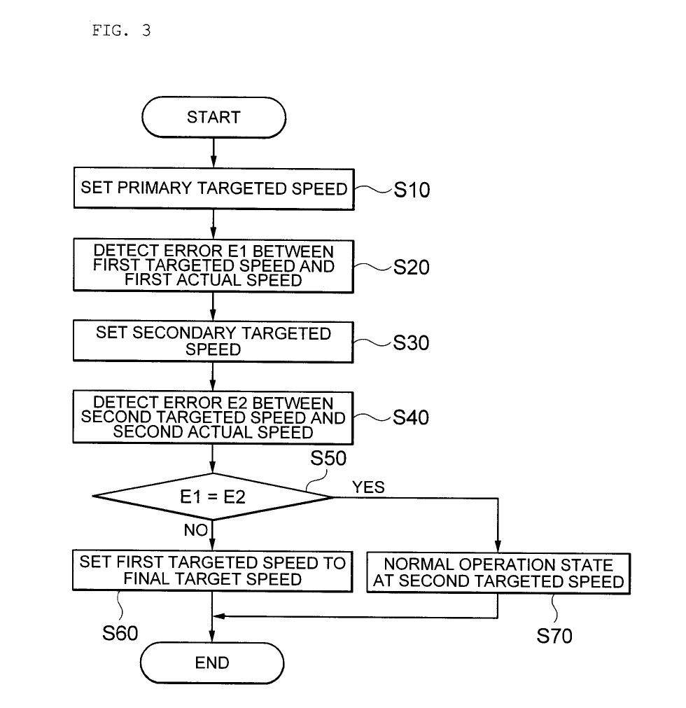

FIG. 3 is a flow chart of a method for controlling a motor speed according to an embodiment of the present invention.

Referring to FIG. 3, the method for controlling a motor speed according to an exemplary embodiment of the present invention may include setting the primary targeted speed (S10), detecting the difference E1 between the first targeted speed and the first actual speed that is the same speed as the first targeted speed (S20), setting the secondary targeted speed (S30), detecting the difference E2 between the second targeted speed and the second actual speed (S40), and determining whether the E1 is equal to the E2 (S50).

Since the first targeted speed is equal to the first actual speed, the E1 is zero and the since the second targeted speed may be equal to or different from the second actual speed, the E2 may be or may not be zero. In this case, when the E2 is zero, the second targeted speed may be set to be the final targeted speed since the second actual speed is normally output at the same speed as the set second targeted speed. Therefore, after the determining (S50), the method for controlling a motor speed may further include setting the second targeted speed to the final targeted speed (S70) when the E1 is equal to the E2 and outputting, by the motor, the second targeted speed.

However, when the E2 is not zero, the speed that does not reach the second targeted speed may be considered to be the case in which the second actual speed is output. The reason is that the actual speed cannot exceed the targeted speed. Therefore, after the determining (S50), the method for controlling a motor speed may further include setting the first targeted speed to the final targeted speed (S60) when the E1 is different from the E2 and outputting, by the motor, the first targeted speed.

Further, after the determining (S50), the method for controlling a motor speed further includes setting the third order targeted speed as long as the E1 is different from the E2 and detecting the difference E3 between the third targeted speed and the third actual speed, wherein the third targeted speed may be higher than the first targeted speed and lower than the second targeted speed.

When the E1 is different from the E, it means that the second actual speed does not reach the second targeted speed. Therefore, it is possible to provide more opportunities of increasing the actual speed by newly setting the third targeted speed increased more than the first targeted speed and reduced more than the second targeted speed. Therefore, the third targeted speed may be higher than the first targeted speed and lower than the second targeted speed.

In this case, after the setting of the third targeted speed, the method for controlling a motor speed may further include setting the third targeted speed to the final targeted speed when the E2 is equal to the E3 and outputting, by the motor, the third targeted speed.

Further, after the setting of the third targeted speed, the method for controlling a motor speed may further include setting the second targeted speed to the final targeted speed when the E2 is different from the E3 and outputting, by the motor, the second targeted speed.

According to the embodiments of the present invention, it is possible to prevent power from being excessively consumed by issuing the meaningless order of a speed increase when the motor is driven at the actual speed.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

What is claimed is:

1. An apparatus for controlling a motor speed, comprising:
a motor;
a targeted speed external setting unit that sets a targeted speed for the motor;
a speed comparing unit that compares the targeted speed with an actual speed of the motor;
an error detecting unit that detects a difference between the targeted speed and the actual speed;
a speed storage unit that is connected with the speed comparing unit to store the targeted speed and the actual speed; and
an error storage unit that is connected with the error detecting unit to store the difference between the targeted speed and the actual speed.

2. The apparatus according to claim 1, further comprising:
a speed measuring unit that is connected with the motor to measure the actual speed and input the measured actual speed to the speed comparing unit; and
a speed control unit that controls the speed of the motor based on the targeted speed set by the targeted speed external setting unit.

3. The apparatus according to claim 1, wherein the error storage unit stores a difference E1 between the first targeted speed and a first actual speed that is the same speed at the time of setting a primary targeted speed first set by the targeted speed external setting unit, and
stores a difference E2 between a second targeted speed and a second actual speed at the time of setting the secondary targeted speed set so as to be increased more than the primary targeted speed by the targeted speed external setting unit.

4. The apparatus according to claim 3, wherein the targeted speed external setting unit sets the second targeted speed to a final targeted speed when the E1 is equal to the E2, and
sets the first targeted speed to the final targeted speed when the E1 is different from the E2.

5. The apparatus according to claim 3, wherein the speed control unit performs a control to output the second targeted speed when the E1 is equal to the E2, and
performs a control to output the first targeted speed when the E1 is different from the E2.

6. The apparatus according to claim 3, further comprising:
a targeted speed internal setting unit that is connected with the speed comparing unit and the speed control unit and sets a third targeted speed that is a new targeted speed different from the targeted speed set by the targeted speed external setting unit as long as the E1 is different from the E2,
wherein speed control unit controls the speed of the motor according to one selected from the targeted speed external setting unit or the targeted speed internal setting unit.

7. The apparatus according to claim 6, wherein the third targeted speed is higher than the first targeted speed and is lower than the second targeted speed.

8. The apparatus according to claim 7, wherein the error storage unit stores a difference E3 between the third targeted speed and a third actual speed at the time of setting a third order targeted speed by the targeted speed internal setting unit.

9. The apparatus according to claim 8, wherein the targeted speed internal setting unit sets the third targeted speed to the final targeted speed when the E2 is equal to the E3, and
sets the second targeted speed to the final targeted speed when the E2 is different from the E3.

10. The apparatus according to claim 8, wherein the speed control unit performs a control to output the third targeted speed when the E2 is equal to the E3, and
performs a control to output the second targeted speed when the E2 is different from the E3.

11. A method for controlling a motor speed, comprising:
setting a primary targeted speed;
detecting a difference E1 between a first targeted speed and a first actual speed that is the same speed as the first targeted speed;
setting a secondary targeted speed;
detecting a difference E2 between a second targeted speed and a second actual speed; and
determining whether the E1 is equal to the E2.

12. The method according to claim 11, further comprising: after the determining,
setting the second targeted speed to a final targeted speed when the E1 is equal to the E2, and
outputting, by the motor, the second targeted speed.

13. The method according to claim 11, further comprising: after the determining,
setting the first targeted speed to a final targeted speed when the E1 is different from the E2, and
outputting, by the motor, the first targeted speed.

14. The method according to claim 11, further comprising: after the determining,
setting a third order targeted speed when the E1 is different from the E2, and
detecting a difference E3 between the third targeted speed and a third actual speed,
wherein the third targeted speed is higher than the first targeted speed and is lower than the second targeted speed.

15. The method according to claim 14, further comprising: after the setting of the third targeted speed,
setting the third targeted speed to a final targeted speed when the E2 is equal to the E3, and
outputting, by the motor, the third targeted speed.

16. The method according to claim 14, further comprising: after the setting of the third targeted speed,
setting the second targeted speed to the final targeted speed when the E2 is different from the E3, and
outputting, by the motor, the second targeted speed.
